(19) United States
(12) Patent Application Publication
(10) Pub. No.: US 2013/0250362 A1
(43) Pub. Date: Sep. 26, 2013

(54) IMAGE PROCESSING APPARATUS AND QUANTIZATION METHOD

(71) Applicant: CANON KABUSHIKI KAISHA, Tokyo (JP)

(72) Inventor: Kaori Taya, Yokohama-shi (JP)

(73) Assignee: CANON KABUSHIKI KAISHA, Tokyo (JP)

(21) Appl. No.: 13/773,406

(22) Filed: Feb. 21, 2013

(30) Foreign Application Priority Data
Mar. 26, 2012 (JP) 2012-070185

(51) Int. Cl. G06K 15/02

(52) U.S. Cl. CPC G06K 15/1878
USPC 358/2.1; 358/1.9

(57) ABSTRACT

When quantizing the color material amount data of a black color and that of a chromatic color, the color material amount data of a first chromatic color is quantized so that the phase of a low spatial frequency component of black color quantization data obtained by quantizing the color amount data of the black color is opposite to that of the low spatial frequency component of first quantization data obtained by quantizing the color material amount data of the first chromatic color, and the high spatial frequency component of the black color quantization data has no correlation with that of the first quantization data.

### BACKGROUND OF THE INVENTION

1. Field of the Invention

The present invention relates to image processing of quantizing color material amount data.

2. Description of the Related Art

The following technique is well known as a technique for achieving excellent color development by enlarging the color gamut (color reproduction range) of an inkjet printer.

A technique disclosed in Japanese Patent Laid-Open No. 6-233126 (literature 1) uses particular color inks such as red (R), green (G), and blue (B) inks in addition to basic color inks including cyan (C), magenta (M), yellow (Y), and black (K) inks. This technique enlarges the color gamut of a red region by, for example, adding the R ink for reproducing a red color with chroma higher than that of a red color obtained by overlap of an M dot and a Y dot.

A technique disclosed in Japanese Patent Laid-Open No. 2004-155181 (literature 2) sets an appropriate print order according to an input color signal. Assume that a Y dot and C dot overlap each other. In this case, color development when a C dot overlaps a Y dot (YC order) is different from that when a Y dot overlaps a C dot (CY order). Therefore, a color which can be reproduced only in the YC order is printed in the YC order, and a color which can be reproduced only in the CY order is printed in the CY order, thereby enlarging the color gamut as compared with a fixed print order.

A technique disclosed in Japanese Patent Laid-Open No. 2005-088579 (literature 3) controls a dot arrangement so that a particular color dot and basic color dot do not overlap each other as much as possible, because the color development of a particular color ink suffers if a particular color dot and another color dot overlap each other. For example, to associate, with a predetermined 2×4 dot arrangement pattern, color material amount data which corresponds to the use amount of a print material and which has been quantized to nine values, and convert the data into binary data indicating whether to print a dot, a dot arrangement pattern different from that for another color is prepared for a particular color. This decreases the probability that a dot of another color overlaps that of a particular color to achieve a sufficiently good color development of the particular color ink, thereby enlarging the color gamut.

The above-described techniques have the following problems. The techniques described in literatures 1 and 3 require inks in addition to the basic color inks. The number of inks increases, and thus the printer structure is complicated and becomes large in size.

The technique described in literature 2 can enlarge, for example, a middle brightness region from yellow through green to cyan. The technique, however, cannot enlarge a low brightness region from yellow to black. Enlargement of the color gamut of the low brightness region is an issue for a printer using pigment inks which have been often used in recent years.

### SUMMARY OF THE INVENTION

In one aspect, an image processing apparatus comprising: a quantization unit configured to quantize color material amount data of a black color, and quantize color material amount data of a chromatic color, wherein the quantization unit quantizes color material amount data of a first chromatic color so that a phase of a low spatial frequency component of black color quantization data obtained by quantizing the color material amount data of the black color is opposite to a phase of a low spatial frequency component of first quantization data obtained by quantizing the color material amount data of the first chromatic color, and a high spatial frequency component of the black color quantization data has no correlation with a high spatial frequency component of the first quantization data.

According to the aspect, it is possible to enlarge the color gamut of a low brightness region in a print image, thereby achieving excellent color development.

Further features of the present invention will become apparent from the following description of exemplary embodiments with reference to the attached drawings.

### BRIEF DESCRIPTION OF THE DRAWINGS

FIG. 1 is a block diagram for explaining the arrangement of an image processing apparatus and printing apparatus according to an embodiment.

FIG. 2 is a flowchart for explaining image processing executed by the image processing apparatus.

FIG. 3 is a block diagram showing the arrangement of an HT processing unit.

FIG. 4 is a flowchart for explaining HT processing for black.

FIGS. 5A and 5B are views showing an example of an error diffusion matrix and cumulative error storage areas.

FIG. 6 is a block diagram showing the arrangement of a restrictive information calculation unit for calculation of black restrictive information.

FIG. 7 is a flowchart for explaining calculation of black restrictive information Kr.

FIG. 8 is a flowchart for explaining HT processing for chromatic colors.

FIG. 9 is a block diagram showing the arrangement of the restrictive information calculation unit for calculation of chromatic color restrictive information.

FIG. 10 is a flowchart for explaining calculation of chromatic color restrictive information KC1r.

FIGS. 11A and 11B are views each showing a dot arrangement obtained by ideal printing.

FIGS. 12A, 12B, 13A, and 13B are views each showing a dot arrangement when misregistration has occurred.

FIGS. 14A and 14B are views showing the arrangement of an HT processing unit according to the second embodiment.

FIG. 15 is a block diagram showing the arrangement of a restrictive information calculation unit for calculation of black restrictive information according to the third embodiment.

FIG. 16 is a flowchart for explaining calculation of black restrictive information Kr according to the third embodiment.

FIGS. 17A to 17D are views each showing an example of a filter.

FIG. 18 is a block diagram showing the arrangement of the restrictive information calculation unit for calculation of chromatic color restrictive information according to the third embodiment.

FIG. 19 is a flowchart for explaining calculation of chromatic color restrictive information KC1r according to the third embodiment.

### DESCRIPTION OF THE EMBODIMENTS

Image processing according to an embodiment of the present invention will be described in detail below with reference to the accompanying drawings.

### First Embodiment

[Apparatus Arrangement]

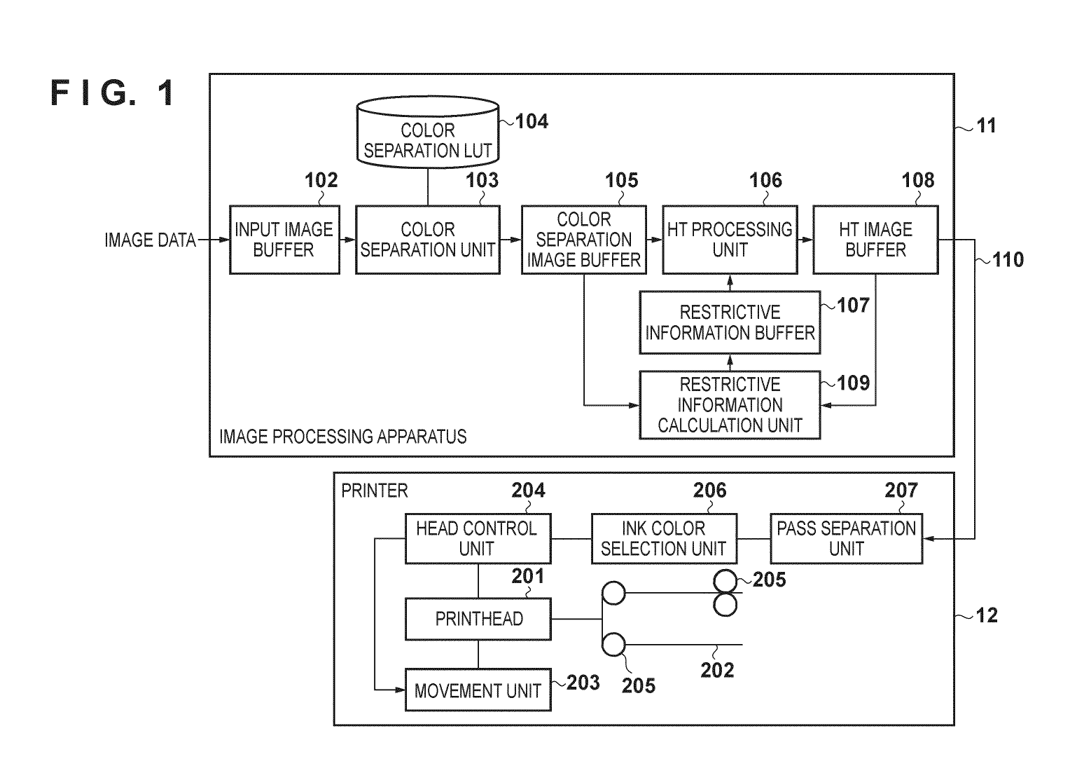

The arrangement of an image processing apparatus and printing apparatus according to the embodiment will be described with reference to a block diagram shown in FIG. 1.

An image processing apparatus 11 is implemented by, for example, installing a printer driver on a general personal computer (PC). That is, the function of each unit (to be described later) of the image processing apparatus 11 is implemented when the microprocessor (CPU) of the PC uses a random access memory (RAM) as a work memory to execute the program of the printer driver. Note that a printer 12 can include the image processing apparatus 11 by providing, in the printer 12, a one-chip microcontroller in which a program for executing the processing of each unit (to be described later) of the image processing apparatus 11 is embedded.

Image Processing Apparatus

An input image buffer 102 of the image processing apparatus 11 stores input image data to be printed. A color separation unit 103 refers to a color separation lookup table (LUT) 104 to perform color separation for input image data as RGB image data to obtain color material amount data (C, M, Y, and K data) corresponding to the ink colors of the printer 12. The color material amount data are stored in a color separation image buffer 105.

Based on values stored in a restrictive information buffer 107, a halftone (HT) processing unit 106 performs halftone processing (HT processing) for the color material amount data (each color has multiple tones such as three or more tones) stored in the color separation image buffer 105 to obtain binary color material amount data for each color. The binary color material amount data are stored in an HT image buffer 108.

The binary color material amount data stored in the HT image buffer 108 are input to the printer 12 via a serial bus 110 such as USB (Universal Serial Bus) for connecting the image processing apparatus 11 with the printer 12.

A restrictive information calculation unit 109 creates restrictive information by predetermined calculation based on the binary color material amount data stored in the HT image buffer 108 and the multi-valued color material amount data stored in the color separation image buffer 105, details of which will be described later. The unit 109 then updates the restrictive information buffer 107 with the created restrictive information.

The restrictive information buffer 107 stores a value (restrictive information) indicating whether a dot at a position on an image to be printed is easily made ON (a dot is easily formed). The restrictive information buffer 107 is prepared for each combination of black (black color) and a chromatic color. If there are one black color and N chromatic colors, NB restrictive information buffers 107 are prepared. Note that NB is given by:

NB=N×(N−1)/2+1 (1)

Printer

The printer 12 is a printing apparatus adopting, for example, a thermal transfer or inkjet method, and moves a printhead 201 in the vertical and horizontal directions with respect to a print medium 202 to form, on the print medium 202, an image indicated by the binary color material amount data input by the image processing apparatus 11 for each band. Note that the printhead 201 has one or more printing elements (nozzles in the inkjet method). Relative movement in the vertical and horizontal directions is implemented when a head control unit 204 controls a movement unit 203 to move the printhead 201, and controls a conveyance unit 205 to convey the print medium 202.

A pass separation unit 207 separates the binary color material amount data for each color input by the image processing apparatus 11 according to multi-pass printing. An ink color selection unit 206 selects an ink color corresponding to the color material amount data input by the pass separation unit 207, from among the ink colors of the printhead 201. Note that although the printhead 201 includes four color (process color) inks, that is, cyan (C), magenta (M), yellow (Y), and black (K) inks in the following example, the combination of colors is not limited to this.

[Image Processing]

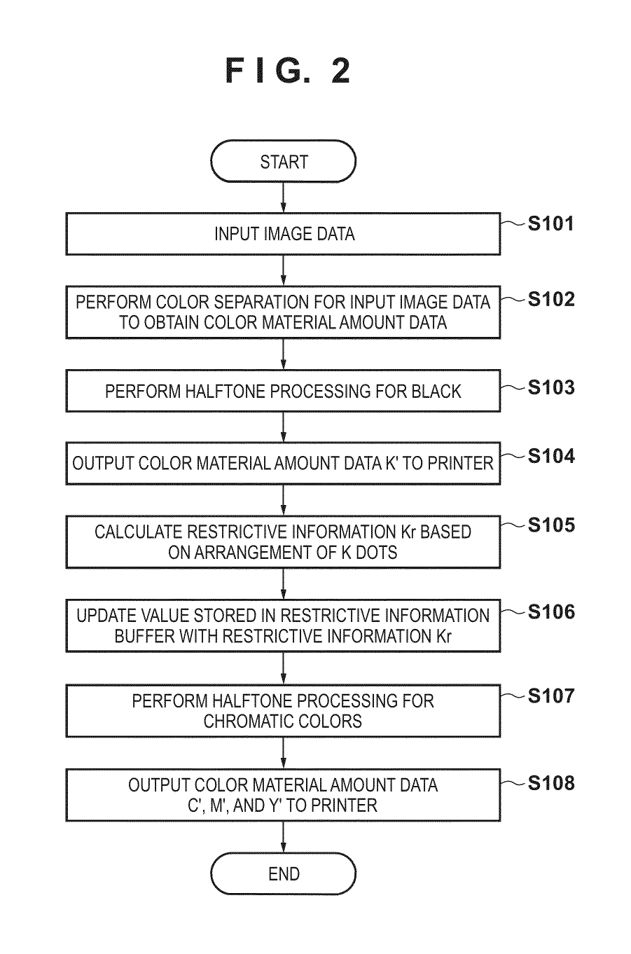

Image processing executed by the image processing apparatus 11 will be described with reference to a flowchart shown in FIG. 2.

When image data is input, the image processing apparatus 11 stores the input image data in the input image buffer 102 (S101). Note that the input image data is RGB image data including 8 bits for each of colors R, G, and B.

The color separation unit 103 of the image processing apparatus 11 performs color separation for the image data stored in the input image buffer 102 to obtain color material amount data (S102). The color material amount data are stored in the color separation image buffer 105. The color separation unit 103 uses a well-known technique to convert the input RGB image data into C, M, Y, and K color material amount data.

C=3DLUT_{C}(R,G,B);

M=3DLUT_{M}(R,G,B);

Y=3DLUT_{Y}(R,G,B);

K=3DLUT_{K}(R,G,B); (2)

Note that 3DLUT_{X} indicates a three-dimensional LUT for generating color material amount data for the color X, which is included in the color separation LUT 104.

The color material amount data is 8-bit image data for each of the colors C, M, Y, and K. The color material amount data, however, need only be multi-tone data, and the number of tones is not limited. As described above, since the printhead 201 includes the four inks, the input image data is converted into image data of four planes of C, M, Y, and K. If the printhead 201 includes inks, the number of which is larger than four, the input image data need only undergo color separation to obtain color material amount data corresponding to the number of inks.

The HT processing unit 106 of the image processing apparatus 11 executes HT processing for black to convert the sum of color material amount data K stored in the color separation image buffer 105 and the value stored in the restrictive information buffer 107 into binary data (S103). The binary color material amount data K (to be referred to as color material amount data K′) having undergone the HT processing is stored in the HT image buffer 108. Note that the HT processing unit 106 quantizes the multi-valued color material amount data to the binary color material amount data using, for example, an error diffusion method or minimized average error method. Note that the result of quantization of the color material amount data will hereinafter sometimes be referred to as “quantization color material amount data.”

As described above, the restrictive information buffer 107 stores restrictive information indicating whether a dot is easily formed at a position on an image to be printed. The restrictive information is updated as the HT image is updated. Note that at the start of the processing, zero is set as an initial value in the restrictive information buffer 107. There are the following four kinds of restrictive information at a position (X, Y):

Kr(X, Y): restrictive information based on an HT image of black;

KC1r(X, Y), KC2r(X, Y): restrictive information based on overlap of HT images of black and one chromatic color; and

KC1C2r(X, Y): restrictive information based on overlap of black and two chromatic colors.

Note that the initial values are

Kr(X,Y)=0,

KC1r(X,Y)=0,

KC2r(X,Y)=0,

and

KC1C2r(X,Y)=0.

Note also that the pieces of restrictive information may be represented by Kr, KC1r, KC2r, and KC1C2r without explicitly indicating the position (X, Y).

The update operation of the restrictive information will be described later. An average of values stored in the restrictive information buffer 107 is zero, a value at a position where a dot is easily formed is positive, and a value at a position where a dot is hardly formed is negative.

The image processing apparatus 11 outputs, for each band, the color material amount data K′ stored in the HT image buffer 108 to the printer 12 (S104). The restrictive information calculation unit 109 calculates restrictive information Kr based on the arrangement of K dots (S105), and updates the value stored in the restrictive information buffer 107 with the restrictive information Kr (S106).

The HT processing unit 106 of the image processing apparatus 11 performs HT processing for a chromatic color to convert the sum of the color material amount data C, M, or Y stored in the color separation image buffer 105 and the value stored in the restrictive information buffer 107 into binary data (S107). The binary color material amount data C, M, or Y (to be referred to as color material amount data C′, M′, or Y′) having undergone the HT processing is stored in the HT image buffer 108. Note that the HT processing unit 106 quantizes the multi-valued color material amount data to the binary color material amount data using, for example, an error diffusion method or minimized average error method.

The image processing apparatus 11 outputs, for each band, the color material amount data C′, M′, and Y′ stored in the HT image buffer 108 to the printer (S108). The image processing apparatus 11 repeats the above processing for each band, and outputs color material amount data corresponding to the input image data to the printer 12.

HT Processing Unit for Black

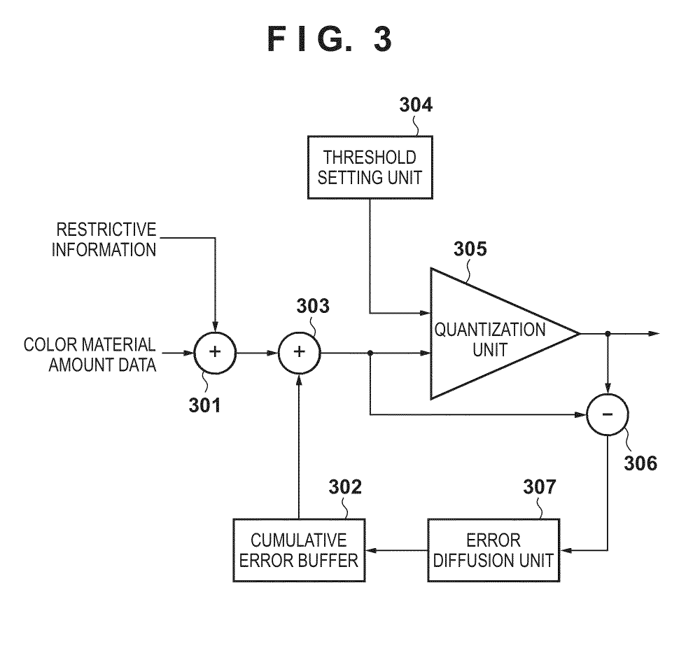

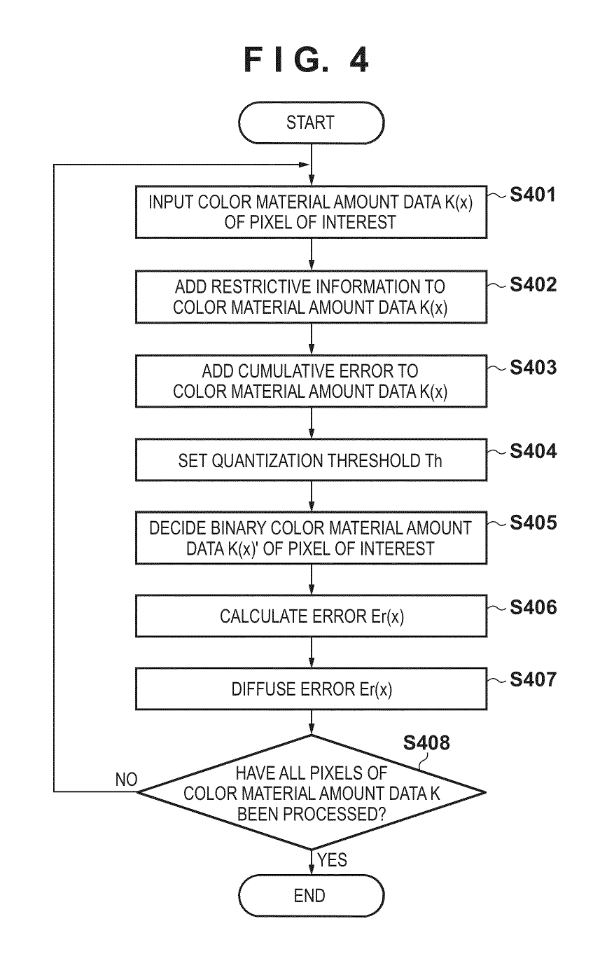

FIG. 3 is a block diagram showing the arrangement of the HT processing unit 106. The HT processing for black will be described with reference to a flowchart shown in FIG. 4.

The HT processing unit 106 receives color material amount data K(x) of a pixel of interest (S401), and causes an addition unit 301 to add the restrictive information to the color material amount data K(x) (S402). Note that since the initial value of the restrictive information is zero, no restrictive information is substantially added in the HT processing for black.

The HT processing unit 106 causes a cumulative error addition unit 303 to add a cumulative error in error diffusion processing to the color material amount data K(x) (S403), and causes a threshold setting unit 304 to set a quantization threshold Th (S404). Note that the quantization threshold Th is set to 128 or the like. To avoid a dot generation delay, however, the threshold Th may be changed according to the color material amount data K(x) so that an average quantization error becomes small, as represented by:

Th(x)=f(K(x)) (3)

As an example of the function f in equation (3), for example, Japanese Patent Laid-Open No. 2002-374412 (literature 4) proposes:

Th(x)={K(x)×(N−1)+128}/N (4)

where N is a natural number of 2 or larger.

After that, a quantization unit 305 decides binary color material amount data K(x)′ of the pixel of interest according to expression (5) (S405). The color material amount data K(x)′ is stored in the HT image buffer 108.

if (Kd<Th)

K(x)′=0;

if (Kd≧Th)

K(x)′=255; (5)

where Kd represents the color material amount data K(x) having undergone the error addition operation.

The HT processing unit 106 causes an error calculation unit 306 to calculate an error Er(x) between the color material amount data Kd having undergone the error addition operation and the binary color material amount data K(x)′ (S406) according to:

Er(x)=Kd−K(x)′ (6)

The HT processing unit 106 causes an error diffusion unit 307 to diffuse the error Er(x) (S407), and quantization of one pixel of black thus ends. A determination is made in step S408 to repeat the processing in steps S401 to S407 until all the pixels of the color material amount data K stored in the color separation image buffer 105 are processed.

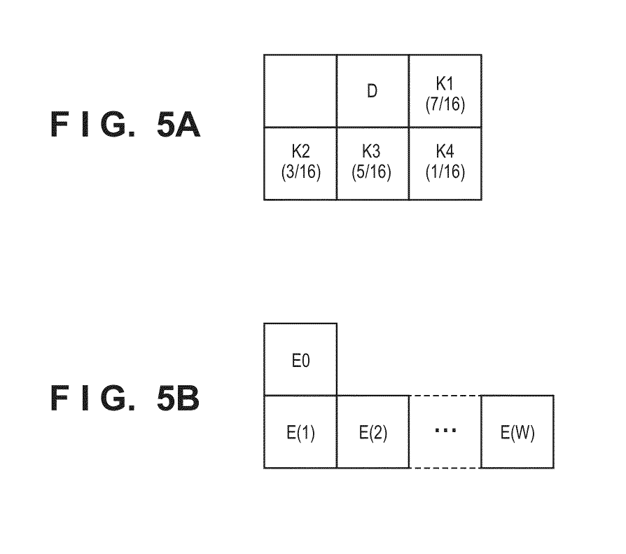

FIGS. 5A and 5B show an example of an error diffusion matrix and cumulative error storage areas. The error diffusion matrix shown in FIG. 5A has a coefficient K1 indicating an error diffused to a neighboring pixel in the main scanning direction with respect to a pixel D of interest, and coefficients K2, K3, and K4 respectively indicating errors diffused to three neighboring pixels in the next row in the sub-scanning direction with respect to the pixel of interest. The values of the error diffusion coefficients are, for example, K1=7/16, K2=3/16, K3=5/16, and K4=1/16. The error diffusion coefficients need not be fixed and may be changed according to the tone of an image, as a matter of course. Furthermore, the number of pixels to which the error is diffused is not limited to four, and the error may be diffused to a larger number of pixels.

A cumulative error buffer 302 accumulates, for each pixel, errors diffused by the error diffusion unit 307. FIG. 5B shows the storage areas of the cumulative error buffer 302. The cumulative error buffer 302 has a storage area E0, and storage areas E(x) (1≦X≦W) the number of which is equal to the number W of pixels in the main scanning direction (horizontal direction) of the input image data. The error diffusion unit 307 stores the cumulative error in the cumulative error buffer 302 according to:

| if (x = 1) | |
|---|---|
| E(x) = E0 + Er(x) × 8/16; | |
| if (1 < x) | |
| E(x − 1) = E(x − 1) + Er(x) × 3/16; | |
| if (1 < x < W) | |
| E(x) = E0 + Er(x) × 5/16; | |
| if (x < W) { | |
| E(x + 1) = E(x + 1) + Er(x) × 7/16; | |
| E0 = Er(x) × 1/16; | |
| }; | |
| if (x = W) { | |
| E(x) = E0 + Er(x) × 13/16; | |
| E0 = 0; | |
| }; | ...(7) |

The cumulative error addition unit 303 adds, to the color material amount data K(x), a cumulative error stored in a storage area E(x) corresponding to a position x of the pixel of interest, as represented by:

Kd=K(x)+E(x) (8)

The HT processing for black decides dot positions formed by a black color material, that is, the quantization color material amount data K′ representing the ON/OFF pattern (dot arrangement) of K dots.

Calculation of Black Restrictive Information

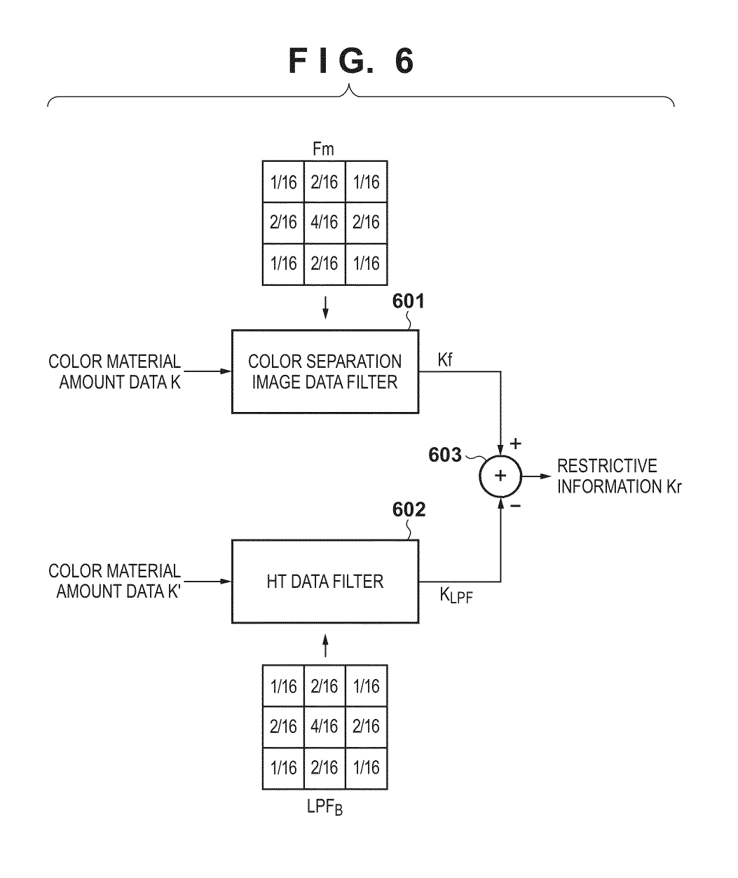

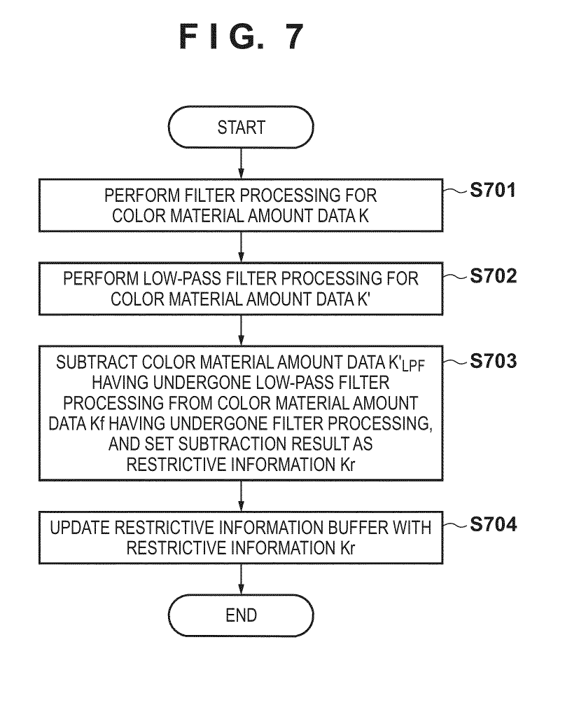

FIG. 6 is a block diagram showing the arrangement of the restrictive information calculation unit 109 for calculation of black restrictive information. Calculation of the black restrictive information Kr will be described with reference to a flowchart shown in FIG. 7.

A color separation image data filter 601 of the restrictive information calculation unit 109 executes, for the color material amount data K stored in the color separation image buffer 105, filter processing represented by:

Kf=K*Fm (9)

where Fm represents a filter and represents convolution (S701).

An example of the filter Fm shown in FIG. 6 is an isotropic weighted average filter which has a size of 3×3 and in which coefficients are concentrically arranged. The filter Fm, however, is not limited to this. The size may be 5×5, 7×7, 9×9, 3×5, 5×7, or 5×9, and a nonisotropic filter in which filter coefficients are elliptically arranged may be used. Note that the filter Fm desirably has low-pass characteristics.

An HT data filter 602 performs, for the color material amount data K′ stored in the HT image buffer 108, low-pass filter processing represented by:

K′_{LPF}=K′*LPF_{B} (10)

where LPF_{B} indicates a low-pass filter (S702).

The low-pass filter LPF_{B} shown in FIG. 6 has the same arrangement as that of the filter Fm. As long as a filter has low-pass characteristics, the present invention is not limited to the arrangement (size and filter coefficients) shown in FIG. 6.

An addition unit 603 sets, as first restrictive information Kr, a difference value obtained by subtracting the color material amount data K′_{LPF} having undergone the low-pass filter processing from the color material amount data Kf having undergone the filter processing (S703) by:

Kr=Kf−K′_{LPF} (11)

The restrictive information calculation unit 109 updates the restrictive information buffer 107 with the restrictive information Kr (S704).

By subtracting the average value of the color material amount data K′ from the average value of the color material amount data K, it is possible to obtain the restrictive information Kr including a small positive or negative value for a K dot ON region, and a large positive value for a K dot OFF region. If HT processing is executed after adding such restrictive information Kr to the color material amount data of a chromatic color, it is possible to control the HT processing so that chromatic color ON dots are hardly arranged in the K dot ON region and chromatic color ON dots are easily arranged in the K dot OFF region. Note that if addition of the color material amount data and the restrictive information causes the color material amount data to fall outside the range (for example, from 0 to 255), the data need only be set to fall within the range (for example, 0 or 255).

HT Processing for Chromatic Color

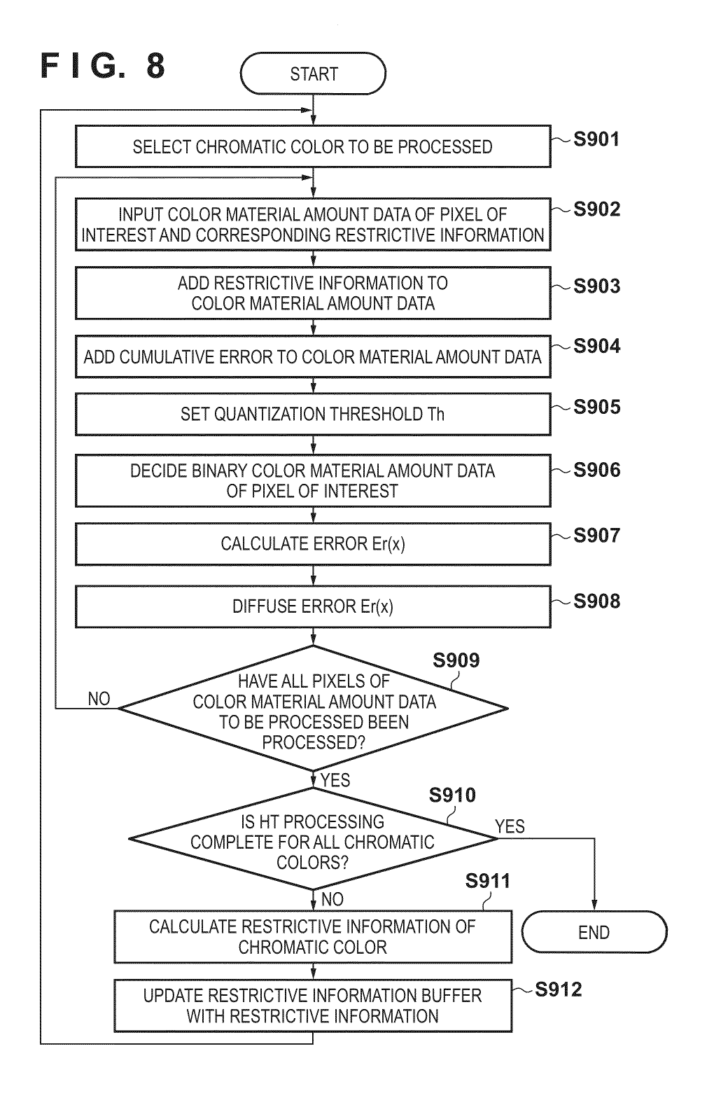

HT processing for chromatic colors will be described with reference to a flowchart shown in FIG. 8.

The HT processing unit 106 selects a chromatic color to undergo the HT processing (S901). The selection order may be the order from a noticeable color to an unnoticeable color, or the descending order of the use amount of color. Assume, in this example, that the unit 106 selects cyan (C) as a first chromatic color.

The HT processing unit 106 receives color material amount data C(x) of a pixel of interest and corresponding restrictive information Kr(x) (S902). The addition unit 301 calculates the sum of the color material amount data C(x) and the restrictive information Kr(x) (S903) by:

C(x)=C(x)+h_{c1}Kr(x) (12)

where h_{c1} is a real number.

The HT processing unit 106 causes the cumulative error addition unit 303 to add a cumulative error in error diffusion processing to the color material amount data C(x) (S904), and causes the threshold setting unit 304 to set the quantization threshold Th (S905). The quantization unit 305 then decides binary color material amount data C(x)′ of the pixel of interest according to expression (13) (S906). The color material amount data C(x)′ is stored in the HT image buffer 108.

if (Cd<Th)

C(x)′=0;

if (Cd≧Th)

C(x)′=255; (13)

where Cd represents the color material amount data C(x) having undergone the error addition operation.

The HT processing unit 106 causes the error calculation unit 306 to calculate an error Er(x) between the color material amount data Cd having undergone the error addition operation and the binary color material amount data C(x)′ (S907) by:

Er(x)=Cd−C(x)′ (14)

The HT processing unit 106 causes the error diffusion unit 307 to diffuse the error Er(x) (S908), and quantization of one pixel of cyan thus ends. A determination is made in step S909 to repeat the processing in steps S902 to S908 until all the pixels of the color material amount data C stored in the color separation image buffer 105 are processed.

The HT processing for cyan decides dot positions formed by a cyan color material, that is, quantization color material amount data C′ representing the ON/OFF pattern (dot arrangement) of C dots.

The HT processing unit 106 determines whether the HT processing is complete for all the chromatic colors (S910). If the HT processing is complete for all the chromatic colors, the HT processing is terminated; otherwise, the restrictive information calculation unit 109 calculates restrictive information.

The restrictive information calculation unit 109 calculates restrictive information KC1r of the chromatic color based on the dot arrangement of the chromatic color (S911). The restrictive information KC1r is used to make the low spatial frequency component of a paper white portion in the dot arrangement of K and the chromatic color (C in this example) be in phase with that of the dot arrangement of a chromatic color to undergo the HT processing next, details of which will be described later. Performing the HT processing for the next chromatic color with reference to the restrictive information KC1r can prevent paper white from occurring as much as possible.

The restrictive information calculation unit 109 updates the restrictive information buffer 107 with the restrictive information (S912). The updated restrictive information (KC1r in this example) is referred to as information for deciding the dot arrangement of the next chromatic color.

The HT processing unit 106 returns the process to step S901 to execute the HT processing for the next chromatic color. Before that, calculation of the restrictive information KC1r will be described.

Calculation of Chromatic Color Restrictive Information KC1r

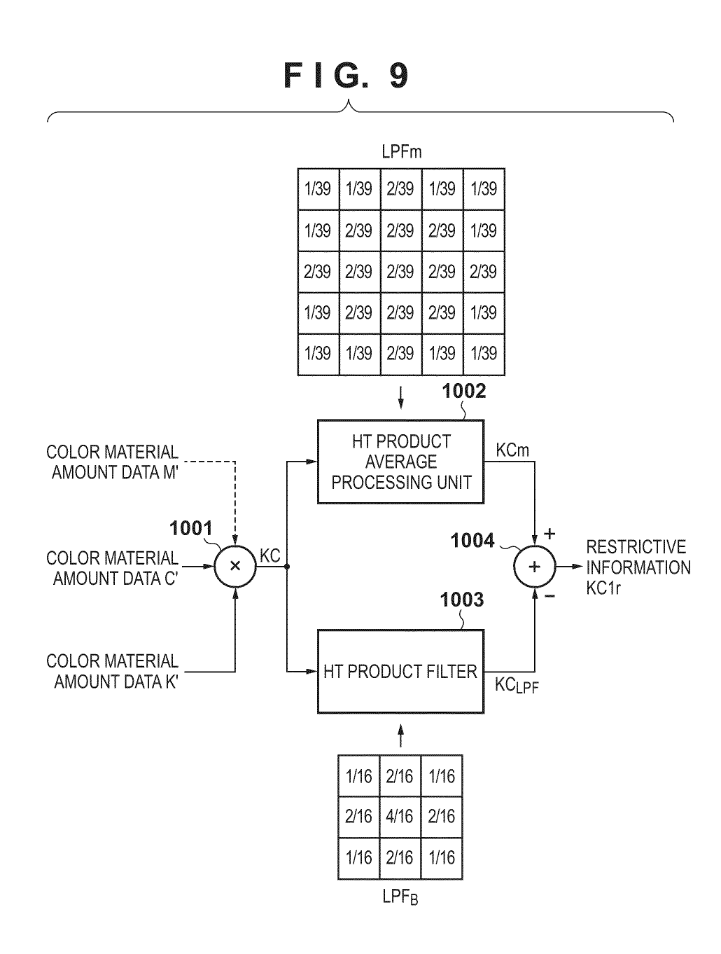

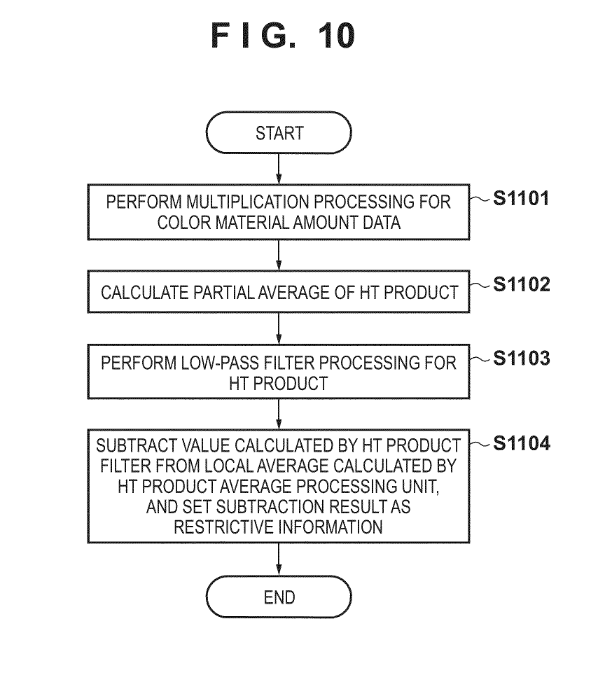

FIG. 9 is a block diagram showing the arrangement of the restrictive information calculation unit 109 for calculation of the chromatic color restrictive information. Calculation (S911) of the chromatic color restrictive information KC1r will be described with reference to a flowchart shown in FIG. 10. Note that the HT processing for the chromatic colors starts from cyan.

A multiplication unit 1001 performs multiplication processing for the color material amount data K′ and C′ stored in the HT image buffer 108 (S1101). That is, the unit 1001 calculates the product KC (to be referred to as an HT product hereinafter) of the color material amount data C′ of cyan and the color material amount data K′ of black by:

KC=255−(255−C′)×(255−K′)/255

or KC=Max (C′,K′) (15)

The above equation is used when 0 indicates dot OFF and 255 indicates dot ON. To the contrary, if 0 indicates dot ON and 255 indicates dot OFF, equation (15′) is used.

KC=C′×K′/255

or KC=Min(C′,K′) (15′)

An HT product average processing unit 1002 calculates the partial average of the HT product KC (S1102). In calculation of the black restrictive information, filter processing is executed for the color material amount data K having undergone black color separation. It is not appropriate to perform filter processing for the product of the color material amount data K and C having undergone black and cyan color separation, respectively, or to perform multiplication for the color material amount data K and C after filter processing. This is because the decision of the dot arrangement of cyan depends on the dot arrangement of black, as follows.

Because of the maintainability of the density in the HT processing, the relationship of the density before and after the HT processing is represented by:

E[K′]=E[K] and E[C′]=E[C] (16)

Since the dot arrangement represented by K′ and that represented by C′ are exclusively decided, expression (17) presented below holds.

E[K′×C′]≠E[K′]×E[C′]=E[K]×E[C] (17)

As represented by expression (17), the density after the HT processing cannot be obtained based on data before the HT processing, and needs to be obtained based on the HT product. Note that this processing is executed to prevent a change in color by correction processing, and an average not for the whole image but for part of the image is obtained. For example, average filter processing represented by equation (18) is executed.

KCm=KC*LPFm (18)

An HT product filter 1003 performs filter processing for the HT product KC using the low-pass filter LPF_{B} (S1103) by:

KC_{LPF}=KC*LPF_{B} (19)

For each pixel, an addition unit 1004 sets, as second restrictive information KC1r, a difference value obtained by subtracting the value calculated by the HT product filter 1003 from the partial average calculated by the HT product average processing unit 1002 (S1104) by:

KC1r=KCm−KC_{LPF} (20)

The filters LPFm and LPF_{B} shown in FIG. 9 are merely examples, and other filters may be used.

Note that the filter LPFm is used to obtain the average of the HT product for a partial region (a 5×5 pixel region in the example shown in FIG. 9), and needs to be different from the filter LPF_{B} functioning as the low-pass filter of a pixel of interest.

Although FIG. 9 and equation (19) show a case in which the same filter LPF_{B} as that used to calculate the black restrictive information is used, another filter may be used. Note that the filter desirably has low-pass characteristics. The processing executed by the HT product average processing unit 1002 is not limited to the filter processing as long as it is possible to obtain the average of the HT product for a partial region. By subtracting the filter of the HT product filter 1003 from that filter, the HT product average processing unit 1002 can execute filter processing including the processing in steps S1102 to S1104.

By subtracting the value obtained by performing the filter processing for the HT product using the filter LPF_{B} from the partial average of the HT product obtained using the filter LPFm, it is possible to obtain restrictive information KC1r including a small positive or negative value for a region where the HT product is 255, and a large positive value for a region where the HT product is 0. If such restrictive information KC1r is added to the color material amount data of a chromatic color, and then HT processing is executed, it is possible to control the HT processing so that chromatic color ON dots are hardly arranged in the region where the HT product is 255 and chromatic color ON dots are easily arranged in the region where the HT product is 0.

HT Processing for Chromatic Color (Second Color)

Upon completion of the HT processing for cyan and calculation of the restrictive information KC1r, the HT processing unit 106 decides a chromatic color to undergo the HT processing next (S901). Assume, in this example, that the unit 106 selects magenta (M) as a second chromatic color.

The HT processing unit 106 receives color material amount data M(x) of a pixel of interest and corresponding pieces Kr(x) and KC1r(x) of restrictive information (S902). The addition unit 301 calculates the sum of the color material amount data M(x) and the pieces Kr(x) and KC1r(x) of restrictive information (S903). For the second color, in addition to the black restrictive condition Kr, the restrictive information KC1r calculated for black and the first chromatic color (cyan in this example) is also added.

M(x)=M(x)+hₘ₁Kr(x)+hₘ₂KC1r(x) (21)

where hₘ₁ and hₘ₂ are real numbers.

The processing in steps S904 to S909 is the same as that for the first color, and a detailed description thereof will be omitted. In this example, in step S910, the HT processing is complete for cyan and magenta but is not complete for yellow. The restrictive information calculation unit 109, therefore, calculates restrictive information.

The restrictive information calculation unit 109 calculates pieces KC2r and KC1C2r of chromatic color restrictive information based on the dot arrangement of the chromatic color (S911). The restrictive information KC2r is used to make the low spatial frequency component of a paper white portion in the dot arrangement of K and the chromatic color (M in this example) be in phase with that of the dot arrangement of a chromatic color to undergo the HT processing next, details of which will be described later. Furthermore, the restrictive information KC1C2r is used to make the low spatial frequency component of a paper white portion in the dot arrangement of K and the chromatic colors (C and M in this example) be in phase with that of the chromatic color to undergo the HT processing next. Performing the HT processing for the next chromatic color with reference to the pieces KC2r and KC1C2r of restrictive information prevents paper white from occurring as much as possible.

The restrictive information calculation unit 109 updates the restrictive information buffer 107 with the restrictive information (S912). The updated pieces (KC2r and KC1C2r in this example) of restrictive information are referred to as information for deciding the dot arrangement of the next chromatic color.

The HT processing unit 106 returns the process to step S901 to execute the HT processing for the next chromatic color. Before that, calculation of the restrictive information KC1C2r will be described. Note that the restrictive information KC2r is calculated by the same processing as that for the restrictive information KC1r, and a description thereof will be omitted.

Calculation of Chromatic Color Restrictive Information KC1C2r

Assume that the HT processing has been executed for cyan and magenta in the order named.

The multiplication unit 1001 shown in FIG. 9 performs multiplication processing for color material amount data K′, C′, and M′ stored in the HT image buffer 108 (S1101). That is, the unit 1001 calculates the product KCM (HT product) of the color material amount data M′ of magenta, the color material amount data C′ of cyan, and the color material amount data K′ of black by:

KCM=255−(255−M′)×(255−C′)×(255−K′)/2552

or

KC=Max(M′,C′,K′) (22)

The above equation is used when 0 indicates dot OFF and 255 indicates dot ON. To the contrary, if 0 indicates dot ON and 255 indicates dot OFF, equation (22′) presented below is used.

KC=M′×C′×K′/255²

or

KC=Min(M′,C′,K′) (22′)

The HT product average processing unit 1002 calculates the partial average of the HT product KCM (S1102) by:

KCMm=KCM*LPFm (23)

The HT product filter 1003 performs filter processing for the HT product KCM using the low-pass filter LPF_{B} (S1103) by:

KCM_{LPF}=KCM*LPF_{B} (24)

For each pixel, the addition unit 1004 subtracts the value calculated by the HT product filter 1003 from the partial average calculated by the HT product average processing unit 1002, and sets the subtraction result as the restrictive information KC1C2r (S1104) by:

KC1C2r=KCMm−KCM_{LPF} (25)

HT Processing for Chromatic Color (Third Color)

Upon completion of the HT processing for cyan and calculation of the pieces KC2r and KC1C2r of restrictive information, the HT processing unit 106 decides a chromatic color to undergo the HT processing next (S901). Assume, in this example, that the unit 106 selects yellow (Y).

The HT processing unit 106 receives color material amount data Y(x) of a pixel of interest and corresponding pieces Kr(x), KC1r(x), KC2r(x), and KC1C2r(x) of restrictive information (S902). The addition unit 301 calculates the sum of the color material amount data Y(x) and the pieces Kr(x), KC1r(x), KC2r(x), and KC1C2r(x) of restrictive information (S903) by:

Y(x)=Y(x)+h_{y1}Kr(x)+h_{y2}KC1r+h_{y3}KC2r+h_{y4}KC1C2r (26)

where h_{y1}, h_{y2}, h_{y3}, and h_{y4} are real numbers.

The processing in steps S904 to S909 is the same as that for the first and second colors, and a detailed description thereof will be omitted. The HT processing unit 106 determines in step S910 that the HT processing is complete for all the chromatic colors, and terminates the HT processing.

[Effects of Enlargement of Color Gamut]

The above-described processing forms the dot pattern of black and that of a chromatic color so that the phases of the low spatial frequency components of the patterns are opposite to each other. Furthermore, the dot patterns of chromatic colors are formed so as to share the phase of the low spatial frequency component (in phase). With this operation, it is possible to exclusively arrange the black dots and the chromatic color dots from each other, and reproduce a color with higher chroma in a low brightness region, thereby enlarging the color gamut.

Furthermore, since the chromatic color dots are arranged so that the low spatial frequency component of a paper white portion in the dot arrangement of the chromatic color and black is in phase with that of a chromatic color to be printed next, it is possible to reduce exposure of paper white. As a result, it is possible to suppress a decrease in density and chroma due to exposure of paper white in a low brightness region.

[Effects of Resistance to Misregistration]

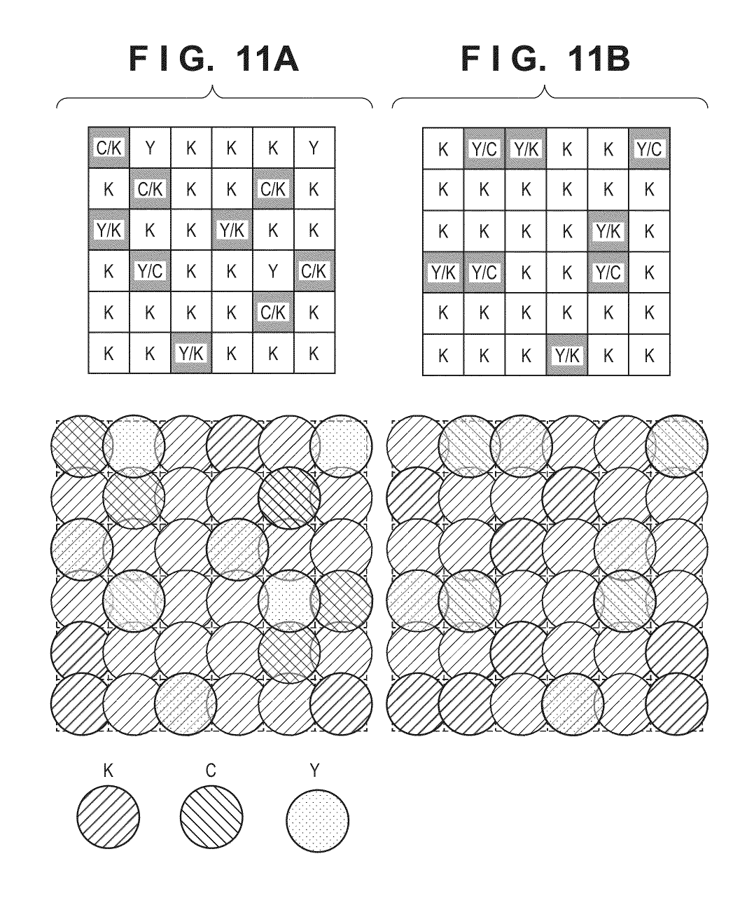

With the above-described processing, that is, the exclusive arrangement of black dots and chromatic color dots and arrangement of chromatic color dots in a paper white portion, it is possible to obtain the effects of resistance to misregistration. The effects of resistance to misregistration will be described. FIGS. 11A, 12A, and 13A each show a dot arrangement according to the embodiment. FIGS. 11B, 12B, and 13B each show a dot arrangement by another exclusive arrangement processing proposed by the applicant.

Assume that one side of each cell shown in each view is about 20 μm (corresponding to 1200 dpi). In the dot arrangements, W within a cell indicates a paper white portion, C/K indicates overlap of a cyan or magenta dot on a black dot, Y/K indicates overlap of a yellow dot on a black dot, and Y/C/K indicates overlap of three kinds of dots. Note that although each view shows paper white between dots diagonally adjacent to each other for the purpose of clarity, there is actually no paper white between dots diagonally adjacent to each other.

FIGS. 11A and 11B each show a dot arrangement obtained by ideal printing. In either the dot arrangement according to the embodiment or the dot arrangement by the other exclusive arrangement processing, no paper white portion W appears. Note that in the dot arrangement (FIG. 11B) by the other exclusive arrangement processing, the overlapping area of black dots and chromatic color dots is smaller (nine cells in FIG. 11A and eight cells in FIG. 11B), and the color gamut of a low brightness region is wider.

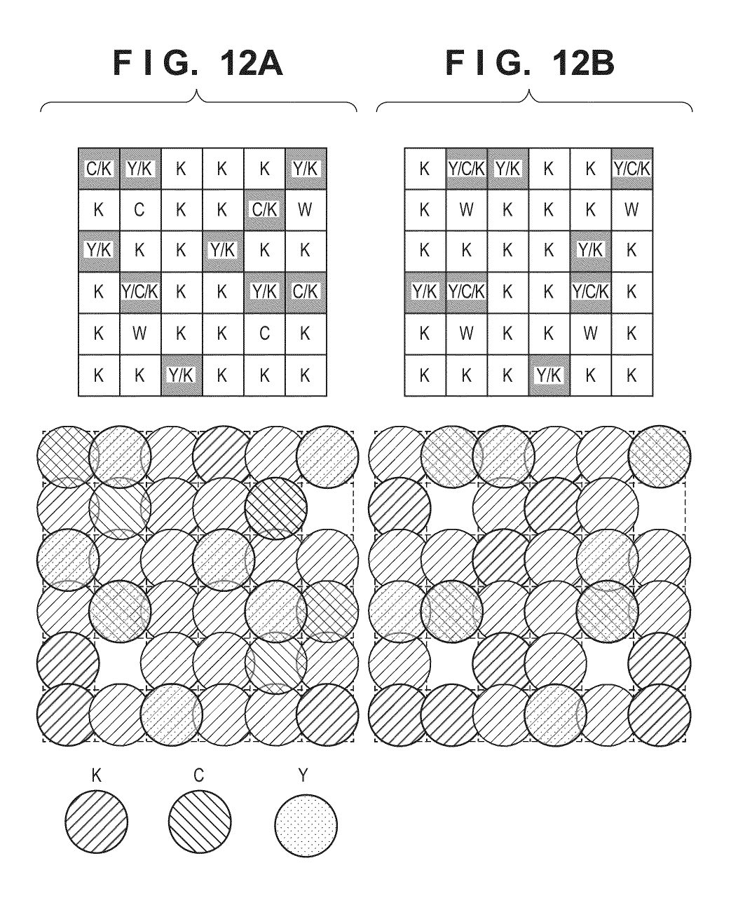

In actual printing, the positions of dots shift due to variations, thereby causing misregistration. FIGS. 12A and 12B each show a dot arrangement when misregistration has occurred. FIGS. 12A and 12B each show a case in which the black dots have been shifted downward by 20 μm (one cell).

In either the dot arrangement (FIG. 12A) according to the embodiment or the dot arrangement (FIG. 12B) by the other exclusive arrangement processing, a paper white portion appears. The area of the paper white portion in FIG. 12A is decreased to half the area in FIG. 12B (two cells in FIG. 12A and four cells in FIG. 12B). This effect is obtained in this embodiment by arranging chromatic color dots so that the low spatial frequency component of the paper white portion is in phase with that of the chromatic color dot.

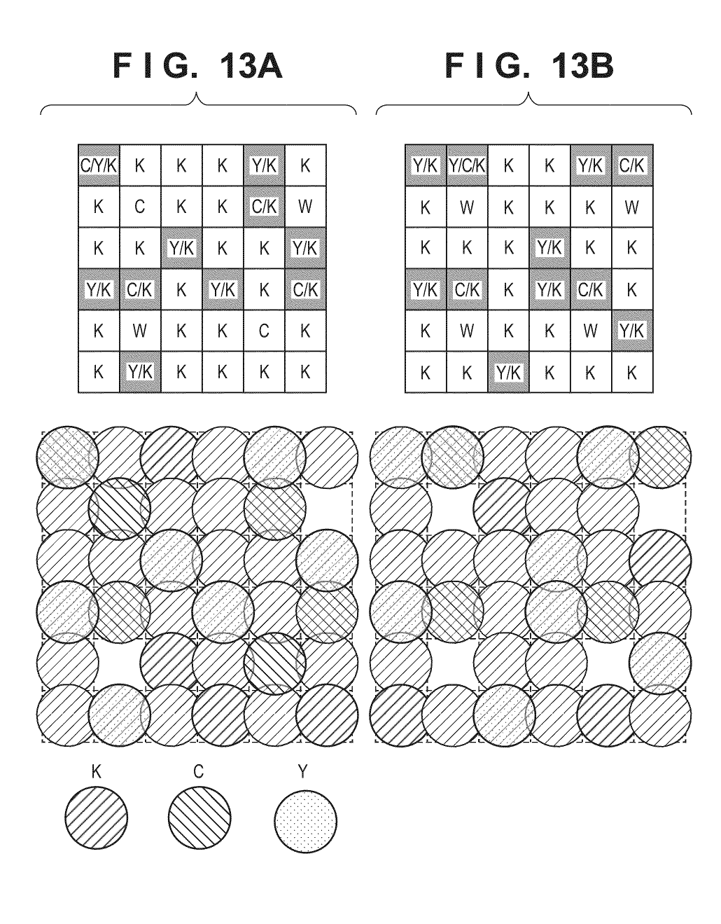

FIGS. 13A and 13B each show a dot arrangement when misregistration has occurred. FIGS. 13A and 13B each show a case in which the black dots have been shifted downward by 20 μm (one cell) and the yellow dots have been shifted leftward by 20 μm (one cell). The area of the paper white portion in the dot arrangement (FIG. 13A) according to the embodiment is decreased to half the area in FIG. 13B (two cells in FIG. 13A and four cells in FIG. 13B). Moreover, the overlapping area of the black dots and chromatic color dots in FIG. 13A is slightly smaller than that in FIG. 13B (10 cells in FIGS. 13A and 11 cells in FIG. 13B). This effect is obtained by exclusively arranging the black dots and chromatic color dots from each other, and making the chromatic color dots share the same low spatial frequency component.

As described above, in actual printing, a combination of the states shown in the above-described views appears in a print region. It is apparent based on the change amount of the rate of occurrence of a paper white portion and a change amount of the overlapping area of the black dots and chromatic color dots that a change in color before and after registration in the other exclusive arrangement processing is larger than that in the embodiment. That is, the processing of the embodiment reduces the color unevenness as compared with the other exclusive arrangement processing.

As described above, it is possible to enlarge the color gamut of a low brightness region, thereby achieving excellent color development and high tonality even if variations that may cause misregistration occur.

### Modification of First Embodiment

Exclusive arrangement processing has been described above in which addition of restrictive information and color material amount data after color separation makes the phase of the low frequency component of the dot arrangement of black opposite to that of the low frequency component of the dot arrangement of a chromatic color, and the high frequency components of the dot arrangements of different colors have no correlation (the phase of the high frequency component of the dot arrangement of black has no correlation with that of the high frequency component of the dot arrangement of a chromatic color, as a matter of course). Note that restrictive information extracted from the low frequency component may be reflected on, for example, the threshold Th of the HT processing or the quantization error Er.

### Second Embodiment

Image processing according to the second embodiment of the present invention will be described below. Note that in the second embodiment, the same components as those in the first embodiment have the same reference numerals, and a detailed description thereof will be omitted.

In the first embodiment, a case in which the HT processing unit 106 executes error diffusion processing has been described. In the second embodiment, a case in which the dither method capable of high-speed processing is used instead of the error diffusion method will be described.

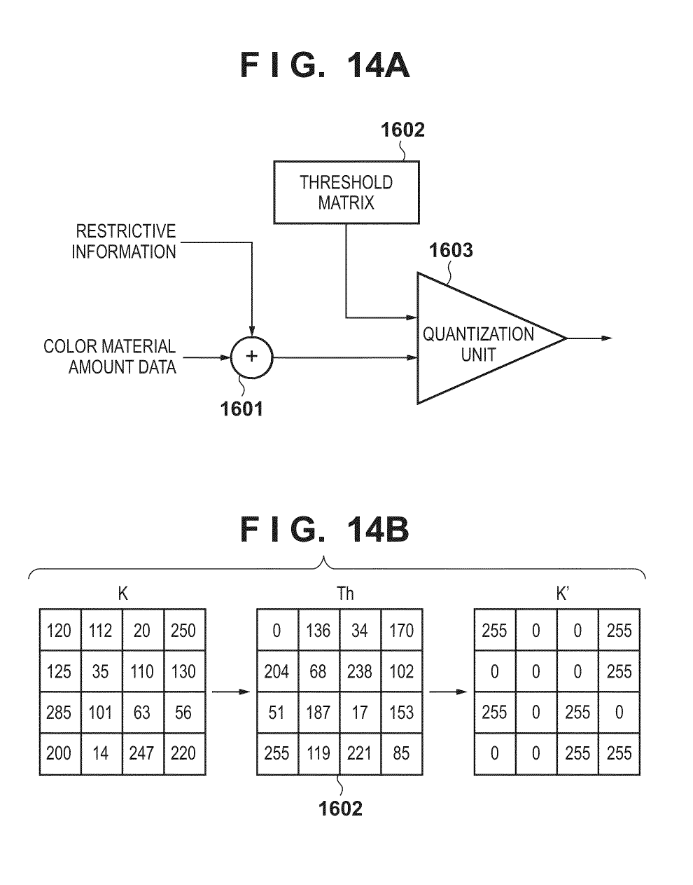

The arrangement of an HT processing unit 106 according to the second embodiment will be explained with reference to FIGS. 14A and 14B.

The HT processing unit 106 shown in FIG. 14A receives color material amount data K(x) of a pixel of interest, and causes an addition unit 1601 to add restrictive information to the color material amount data K(x). Note that as in the first embodiment, the initial value of the restrictive information is zero, and thus no restrictive information is substantially added in HT processing for black.

The HT processing unit 106 causes a quantization unit 1603 to compare the color material amount data K(x) of the pixel of interest with an element (threshold) of a threshold matrix 1602 corresponding to the position of the pixel of interest, thereby outputting binary color material amount data K′(x). FIG. 14B shows an overview of binarization by dither processing in which the color material amount data K(x) is compared with a corresponding threshold Th(x) of the threshold matrix 1602, and undergoes binarization to obtain the color material amount data K(x)′, as represented by:

if(K(x)≦Th(x))

K(x)′=0;

if(K(x)>Th(x))

K(x)′=255; (27)

The above quantization is performed for all the pixels of the color material amount data K, thereby deciding the ON/OFF pattern (dot arrangement) of K dots. Note that the threshold matrix 1602 is well known, and a threshold matrix such as the Bayer array, clustered dot type, and blue noise mask array is used.

HT processing for chromatic colors is obtained by replacing the error diffusion processing in steps S904 to S908 of the processing shown in FIG. 8 with the above-described dither processing. Note that in general, the threshold matrix 1602 is desirably different from that for black. Furthermore, a different threshold matrix may be used for each chromatic color. Calculation of restrictive information is the same as that in the first embodiment, and a description thereof will be omitted.

### Third Embodiment

Image processing according to the third embodiment of the present invention will be described below. Note that in the third embodiment, the same components as those in the first and second embodiments have the same reference numerals, and a detailed description thereof will be omitted.

In the first and second embodiments, a case in which restrictive information is generated using the same filter regardless of the density of an image has been described. In general, however, the spatial frequency characteristics of an HT processing image change depending on the density, and a problem may arise if restrictive information is generated using the same filter. For example, even if there is no problem in a low-density region of an image, granularity may be noticeable in a high-density region of the image. To the contrary, even if there is no problem in a high-density region of an image, the color unevenness may be noticeable in a low-density region of the image. To deal with this problem, in the third embodiment, a different filter is used to generate restrictive information according to the density value of an image, and the frequency characteristics of restrictive information are changed according to the density of the image, thereby preventing image quality depending on the density of the image from deteriorating.

HT processing according to the third embodiment is the same as that in the first or second embodiment except for calculation of restrictive information. Calculation of restrictive information according to the third embodiment will be described below.

Calculation of Black Restrictive Information

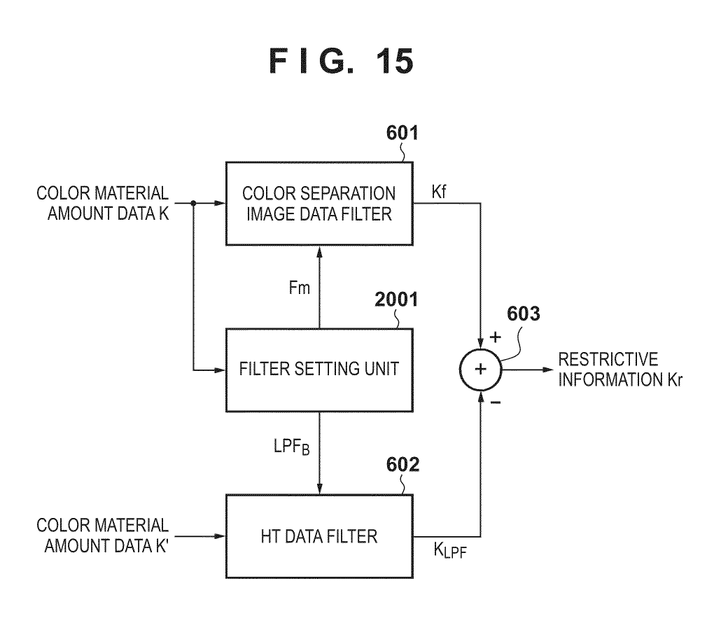

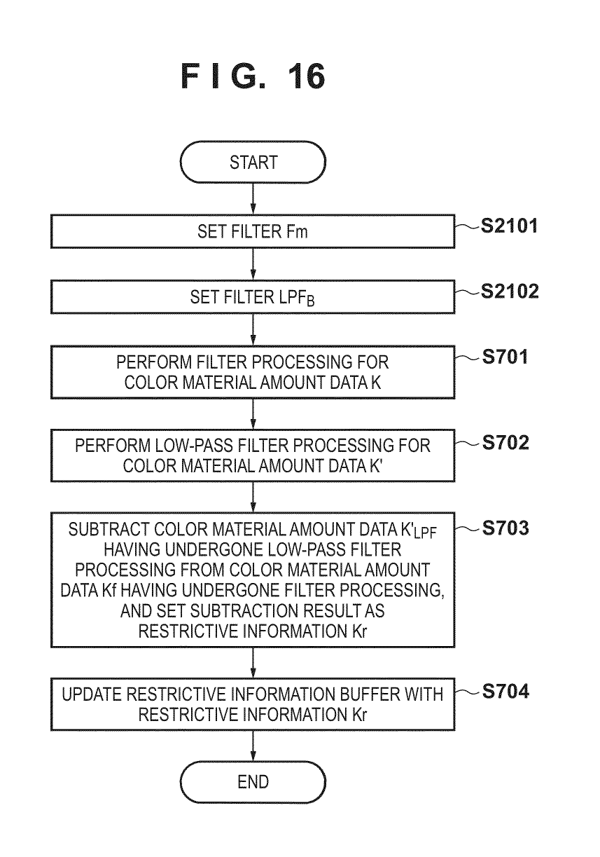

FIG. 15 is a block diagram showing the arrangement of a restrictive information calculation unit 109 for calculation of black restrictive information according to the third embodiment. Calculation of black restrictive information Kr according to the third embodiment will be described with reference to a flowchart shown in FIG. 16.

The arrangement of the restrictive information calculation unit 109 shown in FIG. 15 is different from that in the first embodiment, in that a filter setting unit 2001 is included. The filter setting unit 2001 sets a filter to be used to calculate the restrictive information Kr, based on color material amount data K having undergone color separation. That is, based on the color material amount data K, the filter setting unit 2001 sets a color separation image data filter 601 (Fm) (S2101), and sets an HT data filter 602 (LPF_{B}) (S2102). Processing after that is the same as that in steps S701 to S704 shown in FIG. 7.

The filter setting unit 2001 sets the filter Fm based on the color material amount data K, for example, sets a two-dimensional Gaussian filter by:

Fm=F′m/ΣF′m (28)

where

F′m(K,x,y)={1/(2πσₓ(K)σ_{y}(K))}e^{-p/2},

and

p={x/(σₓ(K))}²−2{x/σₓ(K))}{y/(σ_{y}(K))}+{y/(σ_{y}(K))}².

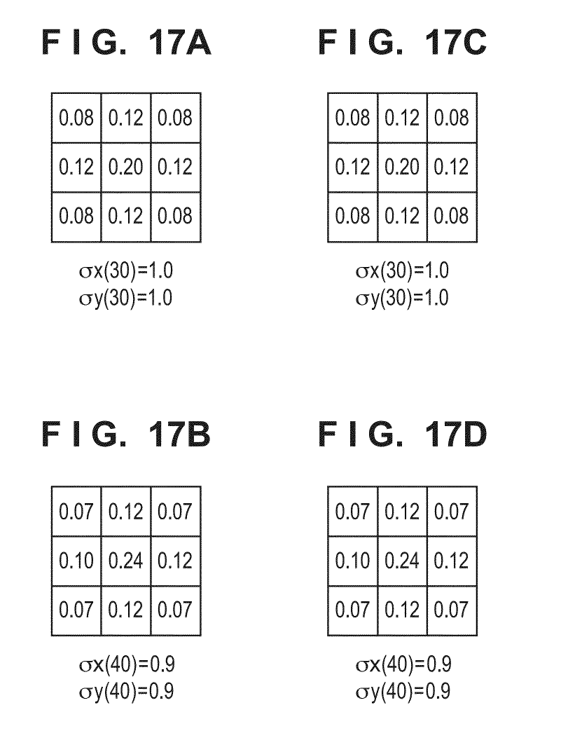

FIGS. 17A to 17D each show an example of a filter. Although a 3×3 square filter is shown for the sake of simplicity, a 5×5, 7×7, or 9×9 square or a 3×5, 5×7, or 5×9 rectangular may be possible. Note that the filter desirably has low-pass characteristics. FIG. 17A shows a filter Fm with σₓ(30)=1.0 and σ_{y}(30)=1.0. FIG. 17B shows a filter Fm with σₓ(40)=0.9 and σ_{y}(40)=0.9.

The filter setting unit 2001 sets the filter LPF_{B} based on the color material amount data K, for example, sets a two-dimensional Gaussian filter by:

LPF_{B}=LPF′_{B}/ΣLPF′_{B} (29)

where

LPF′_{B}(K,x,y)={1/(2πσₓ(K)σ_{y}(K))}e^{-p/2},

and

p={x/(σₓ(K))}²−2{x/σₓ(K))}{y/(σ_{y}(K))}+{y/(σ_{y}(K))}².

FIG. 17C shows a filter LPF_{B} with σₓ(30)=1.0 and σ_{y}(30)=1.0. FIG. 17D shows a filter LPF_{B} with σₓ(40)=0.9 and σ_{y}(40)=0.9.

As shown in FIGS. 17A to 17D, the filter coefficients of the filters Fm and LFP_{B} change depending on the value of the color material amount data K. Note that although FIGS. 17A to 17D show a case in which the same filter coefficients are used in the filters Fm and LPF_{B}, different filter coefficients may be used, as a matter of course.

Calculation of Chromatic Color Restrictive Information KC1r

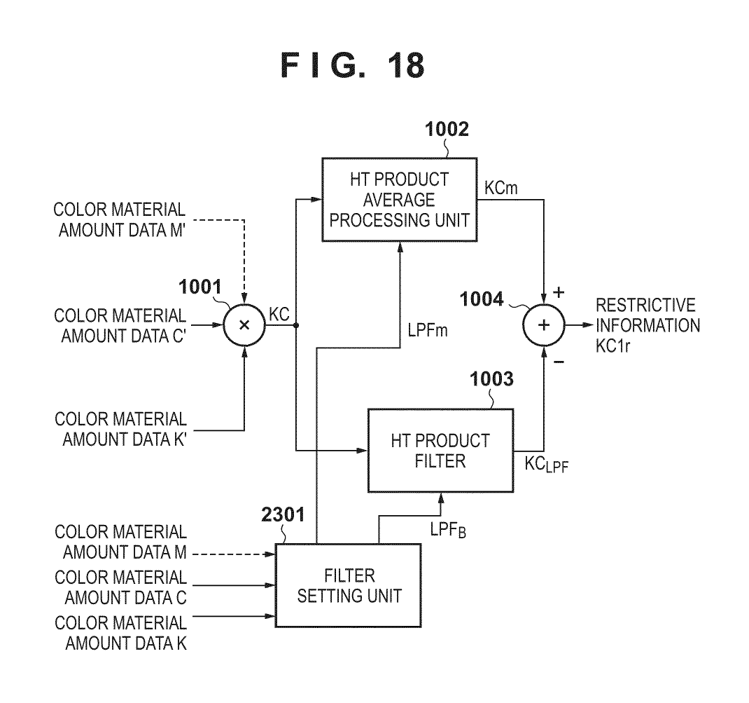

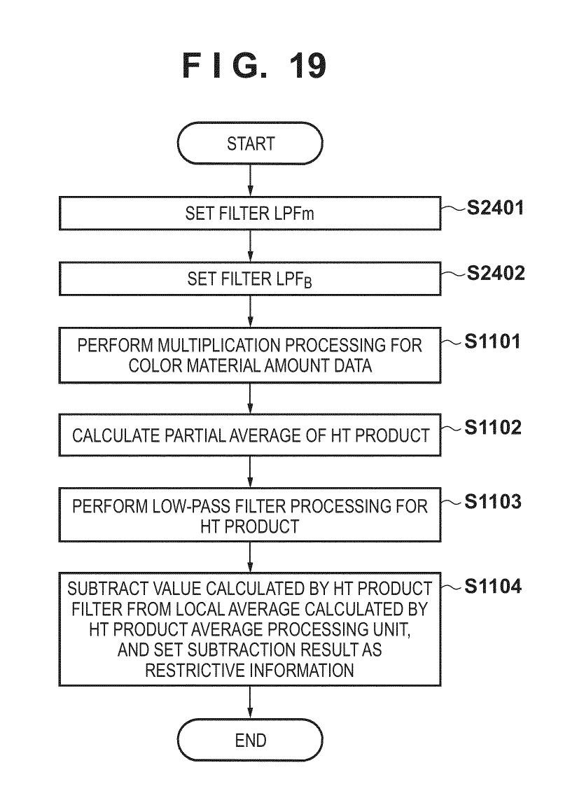

FIG. 18 is a block diagram showing the arrangement of the restrictive information calculation unit 109 for calculation of chromatic color restrictive information according to the third embodiment. Calculation (S911) of chromatic color restrictive information KC1r according to the third embodiment will be described with reference to a flowchart shown in FIG. 19. Note that the HT processing for chromatic colors has started from cyan.

The arrangement of the restrictive information calculation unit 109 shown in FIG. 18 is different from that in the first embodiment, in that a filter setting unit 2301 is included. The filter setting unit 2301 sets a filter to be used to calculate the restrictive information KC1r, based on color material amount data K and C having undergone color separation. That is, based on the color material amount data K and C, the filter setting unit 2301 sets a filter LPFm for an HT product average processing unit 1002 (S2401), and sets an HT product filter 1003 (LPF_{B}) (S2402). Processing after that is the same as that in steps S1101 to S1104 shown in FIG. 10.

The filter setting unit 2301 sets the filter LPFm based on the color material amount data K and C, for example, sets a two-dimensional Gaussian filter by:

LPFm=LPF′m/ΣLPF′m (30)

where

LPF′m(K,C,x,y)={1/(2πσₓ(K,C)σ_{y}(K,C))}e^{-p/2},

and

p={x/(σₓ(K,C))}²−2{x/σₓ(K,C))}{y/(σ_{y}(K,C))}+{y/(σ_{y}(K,C))}².

Note that the filter LPFm shown in FIG. 9 is an example when σₓ(K, C)=1 and σ_{y}(K, C)=1. To obtain sufficient effects, the value of σ desirably becomes larger as K and C are smaller. The filter may be simply implemented by a function having one variable like σ(K+C).

The filter setting unit 2301 sets the filter LPF_{B} based on the color material amount data K and C, for example, sets a two-dimensional Gaussian filter by:

LPF_{B}=LPP′_{B}/ΣLPF′_{B} (31)

where

LPF′_{B}(K,C,x,y)={1/(2πσₓ(K)σ_{y}(K))}e^{-p/2},

and

p={x/(σₓ(K,C))}²−2{x/σₓ(K,C))}{_{y}/(σ_{y}(K,C))}+{y/(σ_{y}(K,C))}².

The filter LPF_{B} is as shown in FIG. 17C or 17D but is not limited to this. Note that since σ is decided based on σₓ(K, C) and σ_{y}(K, C), it is only necessary to set σₓ(10, 10)=0.9 and σ_{y}(10, 10)=0.9 or σₓ(20, 10)=1.0 and σ_{y}(20, 10)=1.0. To obtain sufficient effects, the value of σ desirably becomes larger as K and C are smaller. The filter LPF_{B} preferably has low-pass characteristics.

For calculation of restrictive information KC2r or KC1C2r, σ for a filter need only be decided based on color material amount data having undergone color separation. For example, it is only necessary to set σₓ(10, 10, 10)=0.8 and σ_{y}(10, 10, 10)=0.8 or σₓ(20, 10, 10)=0.9 and σ_{y}(20, 10, 10)=0.9. To obtain sufficient effects, the value of σ desirably becomes larger as K, C, and M are smaller. The filter LPF_{B} preferably has low-pass characteristics.

### Modification of Embodiments

In the above embodiments, there has been described the image processing apparatus adopting an inkjet printing method of causing the printhead 201 having a plurality of nozzles arranged in a predetermined direction to scan the print medium 202 in a direction intersecting the nozzle arrangement direction, and discharging inks on the print medium 202 to form an image. The present invention, however, is applicable to a printing apparatus (for example, the thermal transfer method) for performing printing using a method other than the inkjet method. In this case, a printhead in which printing elements for printing dots are arranged instead of the nozzles for discharging ink droplets is used.

The present invention is also applicable to a so-called full-line type printing apparatus for performing printing by moving the print medium 202 with respect to a printhead with a print width (length) corresponding to the width of the print medium 202.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-070185, filed Mar. 26, 2012, which is hereby incorporated by reference herein in its entirety.

What is claimed is:

1. An image processing apparatus comprising:
a quantization unit configured to quantize color material amount data of a black color, and quantize color material amount data of a chromatic color,
wherein the quantization unit quantizes color material amount data of a first chromatic color so that a phase of a low spatial frequency component of black color quantization data obtained by quantizing the color material amount data of the black color is opposite to a phase of a low spatial frequency component of first quantization data obtained by quantizing the color material amount data of the first chromatic color, and a high spatial frequency component of the black color quantization data has no correlation with a high spatial frequency component of the first quantization data, and
wherein the quantization unit is implemented at least in part by hardware components of the image processing apparatus.

2. The apparatus according to claim 1, wherein the quantization unit quantizes color material amount data of a second chromatic color so that a low spatial frequency component of a paper white portion when the black color quantization data and the first quantization data overlap each other is in phase with a low spatial frequency component of second quantization data obtained by quantizing the color material amount data of the second chromatic color.

3. The apparatus according to claim 1, wherein the quantization unit comprises:
a generation unit configured to generate first restrictive information based on the color material amount data of the black color and the black color quantization data as a value indicating whether a dot of the first chromatic color is easily made ON when quantizing the color material amount data of the first chromatic color; and
a halftoning unit configured to perform halftone processing for a sum of the color material amount data of the first chromatic color and the first restrictive information to obtain the first quantization data.

4. The apparatus according to claim 3, wherein the generation unit sets, as the first restrictive information, a difference value obtained by subtracting a result of performing low-pass filter processing for the black color quantization data from a result of performing low-pass filter processing for the color material amount data of the black color.

5. The apparatus according to claim 3, wherein the generation unit generates second restrictive information based on the black color quantization data and the first quantization data as a value indicating whether a dot of the second chromatic color is easily made ON when quantizing the color material amount data of the second chromatic color, and
wherein the halftoning unit performs halftone processing for a sum of the color material amount data of the second chromatic color and values of the first restrictive information and the second restrictive information to obtain the second quantization data.

6. The apparatus according to claim 5, wherein the generation unit sets, as the second restrictive information, a difference value obtained by subtracting a value obtained by performing low-pass filter processing for a product of the black color quantization data and the first quantization data from a value obtained by performing average processing for the product.

7. The apparatus according to claim 6, wherein the generation unit changes characteristics of the low-pass filter processing and the average processing based on a density indicated by the color material amount data, and changes frequency characteristics of the first restrictive information and the second restrictive information.

8. The apparatus according to claim 1, wherein high spatial frequency components of quantization data of different colors have no correlation with each other.

9. An image processing method comprising:
using a processor to perform the steps of:
quantizing color material amount data of a black color, and
quantizing color material amount data of a chromatic color,
wherein, in the first and second quantizing steps, a phase of a low spatial frequency component of black color quantization data obtained by quantizing the color material amount data of the black color is opposite to a phase of a low spatial frequency component of first quantization data obtained by quantizing first color material amount data of a first chromatic color, and a high spatial frequency component of the black color quantization data has no correlation with a high spatial frequency component of the first quantization data.

10. A non-transitory computer readable medium storing a computer-executable program for causing a computer to perform an image processing method, the method comprising the steps of:
quantizing color material amount data of a black color, and
quantizing color material amount data of a chromatic color,
wherein, in the first and second quantizing steps, a phase of a low spatial frequency component of black color quantization data obtained by quantizing the color material amount data of the black color is opposite to a phase of a low spatial frequency component of first quantization data obtained by quantizing first color material amount data of a first chromatic color, and a high spatial frequency component of the black color quantization data has no correlation with a high spatial frequency component of the first quantization data.
